(19) United States
(12) Patent Application Publication
(10) Pub. No.: US 2007/0080287 A1
(43) Pub. Date: Apr. 12, 2007

(54) PHOTOELECTRIC ACTUATING SYSTEM

(75) Inventors: Wei-Chou Chao, Taipei City (TW); Sen-Tien Wang, Tainan City (TW); Ching-Jung Li, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: Wei-Chou Chao, Taipei City (TW)

(21) Appl. No.: 11/459,028

(22) Filed: Jul. 21, 2006

(30) Foreign Application Priority Data
Oct. 7, 2005 (TW) 94135127

(51) Int. Cl. G06M 7/00

(52) U.S. Cl. 250/221

(57) ABSTRACT

A photoelectric actuating system including a base, an illuminant, at least an optical receiver, at least an actuating apparatus and an optical mechanism is provided. The illuminant is fixed in the base for emitting a light beam. The optical receiver is also fixed in the base. The actuating apparatus is electrically connected to the optical receiver. The optical mechanism can be disposed at an actuating position in the base for transmitting the light beam from the illuminant to the optical receiver so that the optical receiver can send an actuating signal to actuate the actuating apparatus.

### CROSS-REFERENCE TO RELATED APPLICATION

This application claims the priority benefit of Taiwan application serial no. 94135127, filed on Oct. 7, 2005. All disclosure of the Taiwan application is incorporated herein by reference.

### BACKGROUND OF THE INVENTION

1. Field of the Invention

The present invention relates to an actuating system. More particularly, the present invention relates to a photoelectric actuating system.

2. Description of the Related Art

Locks are normally installed around the entrance to the storage area of important data or documents, the doorway into important rooms or the opening to cabinets where precious or important objects are stored to ensure information secrecy and safeguard against property lost.

A conventional lock comprises a key and an actuating system. Typically, the initial state of the actuating apparatus is designed to be in a locked position. In other words, the lock cannot be opened when the key for actuating the actuating apparatus is not in place. When the key is inserted into the keyhole of the actuating apparatus and is rotated in an assigned direction, the mechanical components inside actuating apparatus will move and return the lock to an unlock state.

However, the key for a conventional lock is easy to replicate and the mechanism of the actuating system of a lock is fairly easy to understand so that the lock can be easily opened using a very simple tool (such as a piece of iron wire). Since a conventional lock can be opened with ease, its function in ensuring the security and safety of important documents or precious items is questionable.

### SUMMARY OF THE INVENTION

Accordingly, at least one objective of the present invention is to provide a photoelectric actuating system for increasing the security of an actuating apparatus actuated by such a system.

To achieve these and other advantages and in accordance with the purpose of the invention, as embodied and broadly described herein, the invention provides a photoelectric actuating system comprising a base, an illuminant, at least an optical receiver, at least an actuating apparatus and an optical mechanism. The illuminant is fixed in the base for emitting a light beam. The optical receiver is also fixed in the base. The actuating apparatus is electrically connected to the optical receiver. The optical mechanism can be disposed at an actuating position in the base for transmitting the light beam from the illuminant to the optical receiver so that the optical receiver can send an actuating signal to actuate the actuating apparatus.

According to one preferred embodiment of the present invention, the optical receiver will transmit an actuating signal when the optical receiver receives a light beam having intensity greater than a threshold value.

According to one preferred embodiment of the present invention, the aforementioned illuminant can be laser diode or a light-emitting diode.

According to one preferred embodiment of the present invention, the aforementioned optical receiver can be a photo-resistor, a phototransistor or a photo-detector.

According to one preferred embodiment of the present invention, the aforementioned actuating device can be an electromagnetic switch, a micro-switch or a reed switch.

According to one preferred embodiment of the present invention, the aforementioned optical mechanism can include a carrier and at least an optical element. The optical element is disposed on the carrier. The optical element can be a reflecting mirror, a transparent lens, a semi-transparent/semi-reflective lens or a wave-guide, for example. In addition, the carrier has a positioning structure for positioning the optical mechanism in the actuating position in the base.

Because the light beam from the illuminant is transmitted to the optical receiver through the optical mechanism, the position and the angle of the optical element in the carrier and the properties of the optical element will directly determine whether the transmission to the optical receiver is successful or not. In other words, the optical mechanism is very hard to duplicate. As a result, the security of a locking device can be significantly improved when the photoelectric actuating system of the present invention is used.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a diagram showing a photoelectric actuation system according to a first embodiment of the present invention.

FIG. 2 is a diagram showing the optical mechanism in the photoelectric actuating system in FIG. 1 not positioned in the exact actuating location.

FIG. 3 is a diagram showing a photoelectric actuating system according to a second embodiment of the present invention.

FIG. 4 is a diagram showing a photoelectric actuating system according to a third embodiment of the present invention.

FIG. 5 is a diagram showing a photoelectric actuating system according to a fourth embodiment of the present invention.

FIG. 6 is a diagram showing a photoelectric actuating system according to a fifth embodiment of the present invention.

FIG. 7 is a diagram showing a photoelectric actuating system according to a sixth embodiment of the present invention.

FIG. 8 is a diagram showing a photoelectric actuating system according to a seventh embodiment of the present invention.

FIG. 9 is a diagram showing a photoelectric actuating system according to an eighth embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

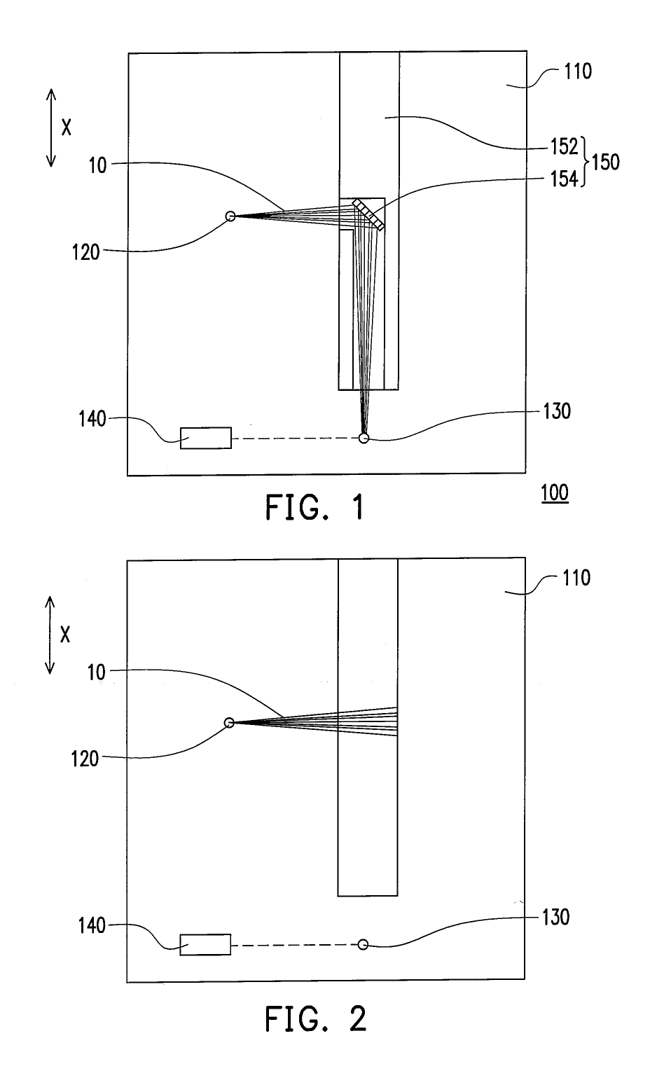

FIG. 1 is a diagram showing a photoelectric actuation system according to a first embodiment of the present invention. As shown in FIG. 1, the photoelectric actuating system 100 comprises a base 110, an illuminant 120, an optical receiver 130, an actuating apparatus 140 and an optical mechanism 150. The base 110 is used for supporting and fixing the illuminant 120 and the optical receiver 130 so that a fixed relative separation exists between the illuminant 120 and the optical receiver 130. In addition, the base 110 can also protect the illuminant 120 and the optical receiver 130 against possible damages inflicted by an external force. The illuminant 120 is a light source that emits a beam of light 10. The actuating apparatus 140 is electrically connected to the optical receiver 130. Furthermore, the actuating apparatus 140 can be disposed in the base 110 so that the base 110 can protect the actuating apparatus 140 against possible damage resulting from an external force. The optical mechanism 150 can be positioned in an actuating position in the base 110 for transmitting the light beam 10 from the illuminant 120 to the optical receiver 130 so that the optical receiver 130 can emit an actuating signal to actuate the actuating apparatus.

FIG. 2 is a diagram showing the optical mechanism in the photoelectric actuating system in FIG. 1 not positioned in the exact actuating location. As shown in FIG. 2, the illuminant 120 and the optical receiver 130 are positioned in separate locations in the base 110. Without the optical mechanism (shown in FIG. 1), the light beam 10 from the illuminant 120 will not be transmitted to the optical receiver 130 and hence the optical receiver 130 will not actuate the actuating apparatus 140.

In other words, the principle of operation between the optical receiver 130 and the actuating apparatus 140 is shown in FIG. 1 as follows. When the intensity of the light beam 10 received by the optical receiver 130 is higher than a threshold value, the optical receiver 130 will emit an actuating signal. The actuating signal is sent to the actuating apparatus 140 for performing a desired operation such as turning on an unlocking switch or triggering a specific apparatus.

As shown in FIG. 1, the optical mechanism 150 can be an assembly that comprises a carrier 152 and at least an optical element 154, for example. The carrier 152 is used for fixing and protecting the optical element 154. In the present embodiment, the optical element 154 is a planar reflecting mirror, for example. In addition, the carrier 152 may include a positioning structure, for example, a square columnar body for positioning the optical mechanism 150 on the actuation position in the base 110. In other words, the optical mechanism 150 can slide along the X direction into or out of the actuating position of the base 110. The positioning structure of the carrier 152 also prevents the optical mechanism 150 from rotating or moving in any other direction. Hence, the light beam 10 from the illuminant 120 will be deflected by 90° and transmitted to the optical receiver 130 after reflecting from the optical element 154 so that the optical receiver 130 can actuate the actuating apparatus 140.

In the aforementioned embodiment, the illuminant 120 can be a laser diode or a light-emitting diode, for example. Furthermore, the optical receiver 130 can be a photo-resistor, a phototransistor or a photo-detector, for example. The common characteristic of all these devices is that they can convert an optical signal into an electrical signal. In addition, the actuating apparatus 140 can be an electromagnetic switch, a micro-switch or a reed switch. All these devices are capable of executing some other switching action on receiving the electrical signal transmitted from the optical receiver 130.

Accordingly, the photoelectric actuating system 100 in the present invention can replace the conventional locks and provide a safe and secure protection against items or persons. Because the light beam 10 from the illuminant 120 is transmitted to the optical receiver 130 through the optical mechanism 150, the position and the angle of the optical element 154 in the carrier 152 will directly determine whether the transmission to the optical receiver 130 is successful or not. Since the optical mechanism 150 is very hard to duplicate, the security of a locking device can be significantly improved when the photoelectric actuating system 100 of the present embodiment is used.

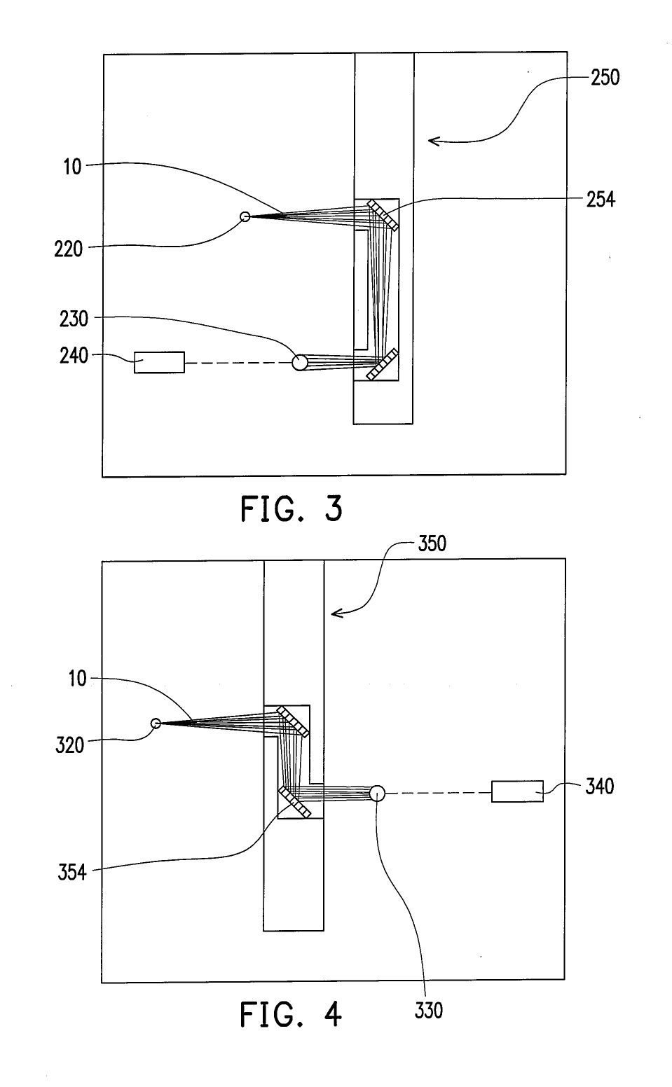

FIG. 3 is a diagram showing a photoelectric actuating system according to a second embodiment of the present invention. The present embodiment differs from the first embodiment in that the optical mechanism 250 comprises two optical elements 254 and the two optical elements 254 are planar reflecting mirrors. Furthermore, the illuminant 220 and the optical receiver 230 are located on the same side of the optical mechanism 250. Therefore, the light beam 10 emitted from the illuminant 220 will deflect 180° after reflecting twice through the two optical elements 254 and transmit to the optical receiver 230 so that the optical receiver 230 can actuate the actuating apparatus 240.

FIG. 4 is a diagram showing a photoelectric actuating system according to a third embodiment of the present invention. The present embodiment differs from the second embodiment in that the illuminant 320 and the optical receiver 330 are located on the opposite sides of the optical mechanism 350. Furthermore, the two optical elements 354, which are two planar reflecting mirrors, are disposed in an orientation that differs from the second embodiment. Thus, after a twice reflection by the two optical elements 354, the light beam 10 from the illuminant 320 is transmitted to the optical receiver 330 in a direction in parallel to the original direction so that the optical receiver 330 can actuate the actuating apparatus 340.

The three aforementioned embodiments show that the illuminants 120, 220, 320 and the optical receivers 130, 230, 330 relative to the positions of the optical mechanisms 150, 250, 350 can be disposed in a number of ways depending on the actual requirements. Hence, a detailed description in this respect will not be repeated in the following embodiments. From now on, the focus is on the relative positioning of the optical elements inside the optical mechanism.

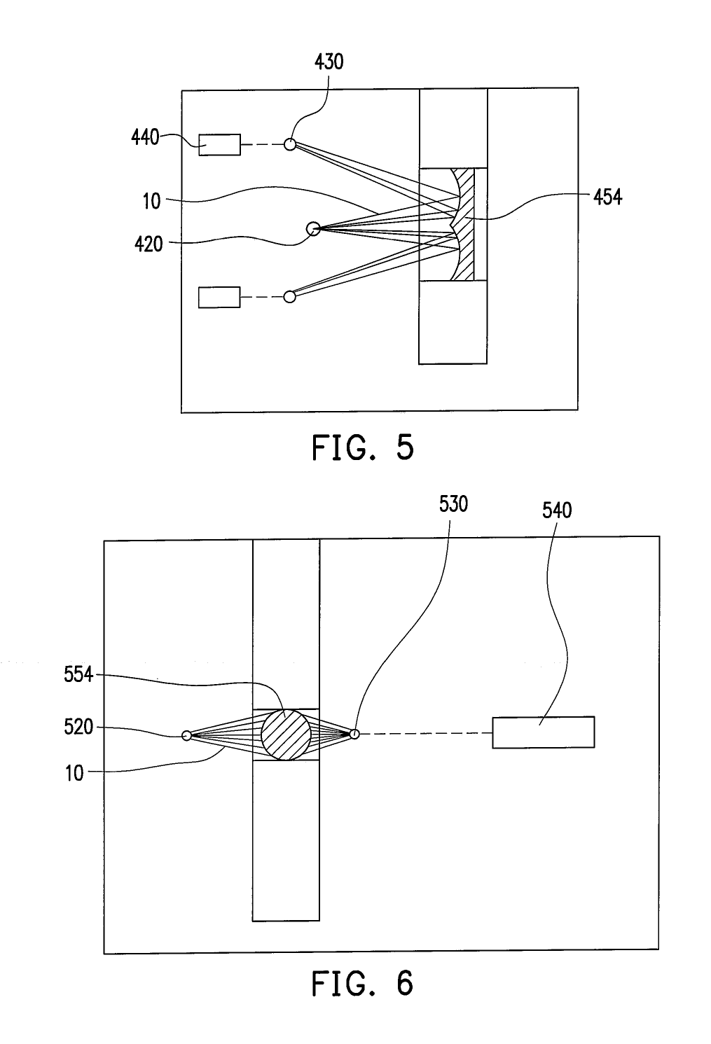

FIG. 5 is a diagram showing a photoelectric actuating system according to a fourth embodiment of the present invention. The optical element 454 comprises two concave mirrors for transmitting a light beam 10 from the illuminant 420 to two optical receivers 430 on the same side as the illuminant 420. The two optical receivers 430 actuate two separate actuating apparatuses 440.

FIG. 6 is a diagram showing a photoelectric actuating system according to a fifth embodiment of the present invention. The optical element 554 is a convex lens with focusing capability. Hence, a light beam 10 from the illuminant 520 will focus on the optical receiver 530 so that the optical receiver 530 can actuates the actuating apparatus 540.

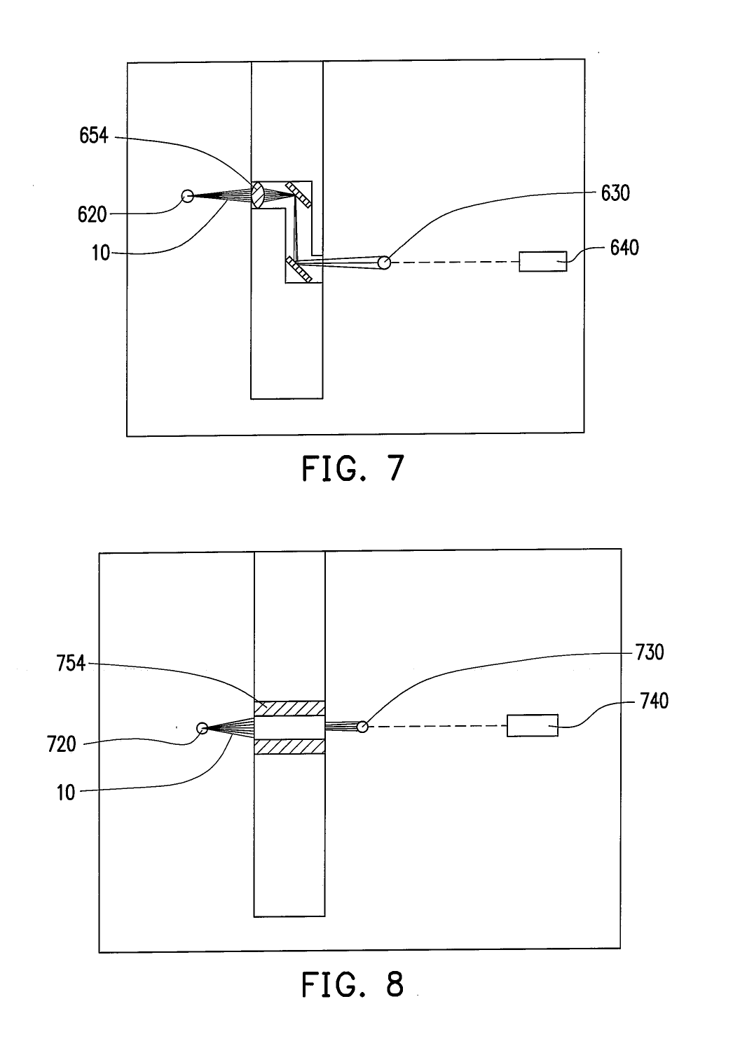

FIG. 7 is a diagram showing a photoelectric actuating system according to a sixth embodiment of the present invention. The three optical elements 654 in the system include a convex lens with focusing capability and two planar reflecting mirrors. The convex lens focuses a light beam 10 from the illuminant 620. Then, the focused light beam travels to the optical receiver 630 after two more reflections by the planar reflecting mirrors so that the optical receiver 630 can actuate the actuating apparatus 640.

FIG. 8 is a diagram showing a photoelectric actuating system according to a seventh embodiment of the present invention. The optical element 754 is a wave-guide that allows the transmission of light along an optical path. A light beam 10 from the illuminant 720 is transmitted to the optical receiver 730 through the optical wave-guide so that the optical receiver 730 can actuate the actuating apparatus 740.

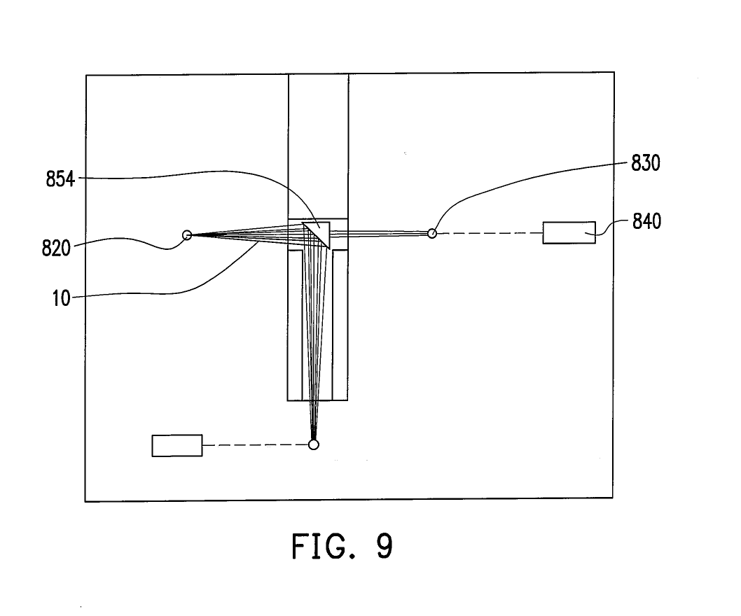

FIG. 9 is a diagram showing a photoelectric actuating system according to an eighth embodiment of the present invention. The optical element 854 is a semi-transparent/semi-reflective prism. A light beam 10 from the illuminant 820 is split up after encountering the prism. As a result, part of the light passes through the prism and travels to an optical receiver 830 to actuate an actuating apparatus 840 while the remaining part of the light is reflected by the prism and travels to another optical receiver 830 to actuate another actuating apparatus 840.

In summary, the photoelectric actuating system in the present invention can replace the conventional locks and provide a safe and secure protection against items or persons. Because the light beam from the illuminant is transmitted to the optical receiver through the optical mechanism, the position and the angle of the optical element in the carrier and the intrinsic properties of the optical element will directly determine the successful transmission to the optical receiver. Since the optical mechanism is very hard to duplicate, the security of a locking device can be significantly improved when the photoelectric actuating system of the present embodiment is used.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A photoelectric actuating system, comprising:
a base;
an illuminant fixed in the base for emitting a beam of light;
at least an optical receiver fixed in the base;
at least an actuating apparatus electrically connected to the optical receiver; and
an optical mechanism suitable for positioning in an actuating position of the base and allowing the transmission of a beam of light from the illuminant to the optical receiver so that the optical receiver can emit an actuating signal to actuate the actuating apparatus.

2. The photoelectric actuating system of claim 1, wherein the optical receiver emits an actuating signal when the optical receiver receives a light beam having a light intensity higher than a threshold value.

3. The photoelectric actuating system of claim 1, wherein the illuminant includes a laser diode or a light-emitting diode.

4. The photoelectric actuating system of claim 1, wherein the optical receiver includes a photo-resistor, a phototransistor or a photo-detector.

5. The photoelectric actuating system of claim 1, wherein the actuating apparatus includes an electromagnetic switch, a micro-switch or a reed switch.

6. The photoelectric actuating system of claim 1, wherein the optical mechanism includes:
a carrier; and
at least an optical element disposed on the carrier.

7. The photoelectric actuating system of claim 6, wherein the optical element includes a reflecting mirror, a lens, a semi-transparent/semi-reflective lens or a wave-guide.

8. The photoelectric actuating system of claim 6, wherein the carrier has a positioning structure for positioning the optical mechanism in the actuating position of the base.
